(19) United States
(12) Patent Application Publication
(10) Pub. No.: US 2025/0282052 A1
(43) Pub. Date: Sep. 11, 2025

(54) Safety Device for Safeguarding a Danger Zone of an Automated Machine, in Particular a Robot

(71) Applicant: Pilz GmbH & Co. KG, Ostfildern (DE)

(72) Inventors: Onedin IBROCEVIC, Ostfildern (DE); Fahri DEMIRCI, Ostfildern (DE)

(21) Appl. No.: 19/218,745

(22) Filed: May 27, 2025

Related U.S. Application Data
(63) Continuation of application No. PCT/EP2023/083734, filed on Nov. 30, 2023.

(30) Foreign Application Priority Data
Nov. 30, 2022 (DE) 10 2022 131 773.0

(51) Int. Cl. B25J 9/16; B25J 19/02

(52) U.S. Cl. CPC B25J 9/1676; B25J 19/021; B25J 19/026

(57) ABSTRACT

A safety device for safeguarding a danger zone of an articulated robot having a body part which, during operation, executes a rotary movement about an axis of rotation during robot operation and thereby defines a current direction of rotation. The safety device includes multiple sensors and an evaluation and control unit. The sensors are configured to be mechanically coupled to the body part such that the sensors move together with the body part in the current direction of rotation during robot operation. The evaluation and control unit is configured to control the rotary movement of the body part in response to sensor signals from the sensors.

### CROSS-REFERENCE TO RELATED APPLICATIONS

This application is a continuation of International Application No. PCT/EP2023/083734 filed Nov. 30, 2023, which claims priority to DE 10 2022 131 773.0 filed Nov. 30, 2022. The entire disclosures of the above applications are incorporated by reference.

### FIELD

The present invention relates to a safety device for safeguarding a danger zone of an automatically operating machine, in particular for safeguarding the danger zone of a robot. More particularly, the invention relates to a safety device having a plurality of sensors configured to be mechanically coupled to a rotating body part of a machine such that the plurality of sensors move together with the body part in a direction of rotation during machine operation. The invention further relates to an automatically operated machine having such a safety device.

### BACKGROUND

For many years, there have been a desire and efforts to safeguard the danger zone resulting from the rapid movements of a robot as simply and flexibly as possible in order to prevent accidents and injuries. In particular, it is desirable to have a safeguard that allows a person to remain in the vicinity of the robot and carry out any activities, for example to enable the person and the robot to work together. Such efforts are known as human-robot collaboration. The two-part standard EN ISO 10218 defines requirements for collaborative operation of a robot. For example, predefined contact forces on the person must not be exceeded in the event of contact be-tween the robot and the person. As a result, it is known that the position, force and/or torques and/or the speed at which the robot or parts of the robot's body move must be monitored and, if necessary, limited. The monitoring and limitation must also be guaranteed in the event of a failure, i.e. it must be fail-safe, for example if a component fails or in the event of a software error

In the following, the term “fail-safe” is used to express that a component or arrangement fulfills the requirements of category 3 or the requirements for the so-called performance level PL d according to the standard EN ISO 13849-1 and/or the safety requirement level SIL 3 according to the standard IEC 61508 as well as the machine-specific sector standard EN 62061.

EP 3 909 727 A1 discloses a safety device having a total of six presence sensors, all of which are arranged on a U-shaped holder. Three presence sensors are respectively arranged vertically one on top of each other on a respective one of the two legs of the U-shaped holder. The respective opposing sensors “look” in opposite directions and monitor areas at the side of the robot. The holder with the six presence sensors is arranged on a lever mechanism, which in turn is attached to the robot arm. The lever mechanism moves in a direction opposite to the movements of the robot arm so that the holder with the presence sensors is always held in a horizontal position and the vertical alignment of the sensors is maintained. The presence sensors arranged one above the other on each side each monitor a spherical sector-shaped spatial segment. The spatial segments are vertically staggered on each side and thus monitor the spatial area to the side of the robot at different heights and lateral distances from the robot. The two lowest sensors on each side monitor an area close to the robot. If a person or object is detected in this close range, the movement of the robot is stopped. The two middle sensors on each side monitor a more distant area. If a person or an object is detected in this more distant area, the robot is moved at a reduced speed.

WO 2018/145990 A1 discloses a further safety device for safeguarding a robot. On the one hand, this known device uses a sensor permanently installed in the floor area of the robot, which sensor can be, for example, a safety mat, a laser sensor, a camera or an ultrasonic sensor. The permanently installed sensor is used to monitor the floor area around the robot. In addition, the safety device of WO 2018/145990 A1 comprises a further sensor at the free end of the robot arm in the area of the so-called end effector. The further sensor is arranged vertically above the end effector and monitors an umbrella-shaped, downward-facing sensor field. The additional sensor can be a laser sensor, a camera or an ultrasonic sensor. The ground-level sensor field of the permanently installed sensor can be divided into several concentric sub-circles, with each sub-circle being assigned a different safety level. Different safety levels can be associated with different movement speeds of the robot.

WO 2006/024431 A1 discloses a further safety device for safeguarding a robot. This de-vice comprises eight ultrasonic proximity sensors permanently installed in the floor area of the robot, each of which proximity sensors monitors a defined sector. The monitored sectors are distributed like a fan over approx. 180° around the robot. The safety device also comprises fences or light barriers that prevent lateral access to the robot behind the monitored sectors, as well as a rear-mounted laser scanner that monitors the fenced area on the back of the robot at ground level. A safety controller ensures that the robot switches to a slower mode or is even stopped if a person moves into a sector that is within the range of the current position of the robot arm.

The known safety devices are in principle suitable for achieving safe operation of a robot. However, they partly impair the productivity of the robot because its movement speed is often limited to a very slow speed for safety reasons, even if this would not be necessary on closer inspection. In addition, some of the known safety devices require a large number of sensors that monitor static spatial areas around the robot.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Against this background, it is an object of the present invention to provide a safety device of the type mentioned at the beginning, which enables the safeguarding of a robot or a similar machine in an efficient manner.

It is another object to provide a safety device that enables high productivity of the robot without endangering persons in the vicinity of the robot.

It is yet another object to provide an automatically operated machine having a rotating body part and a safety device that allows efficient but safe operation of the machine.

According to one aspect, there is provided a safety device for safeguarding a danger zone of an articulated robot having a body part which, during operation, executes a rotary movement about an axis of rotation during robot operation and thereby defines a current direction of rotation, the safety device comprising a plurality of sensors configured to be mechanically coupled to the body part such that the plurality of sensors move together with the body part in the current direction of rotation during robot operation, and comprising an evaluation and control unit configured to control the rotary movement of the body part in response to sensor signals from the plurality of sensors, wherein the plurality of sensors comprise a first sensor configured to monitor a first defined spatial sector and to generate a first sensor signal when an object is detected in the first spatial sector, wherein the plurality of sensors comprise a second sensor configured to monitor a second defined spatial sector and to generate a second sensor signal when an object is detected in the second spatial sector, wherein the plurality of sensors comprise a third sensor configured to monitor a third defined spatial sector and to generate a third sensor signal when an object is detected in the third spatial sector, wherein the first spatial sector, the second spatial sector and the third spatial sector are different from each other, wherein the first and second spatial sectors are adjacent to one another during robot operation, wherein the second and third spatial sectors are adjacent to one another during robot operation, wherein the first spatial sector, the second spatial sector and the third spatial sector are distributed around the axis of rotation during robot operation such that the first spatial sector, the second spatial sector and the third spatial sector follow one another in the current direction of rotation when the body part rotates about the axis of rotation.

According to another aspect, there is provided an automatically operating machine having a machine body part which, during machine operation, is configured to rotate about an axis of rotation, thereby defining a current direction of rotation, the machine comprising a safety de-vice comprising a plurality of sensors configured to be mechanically coupled to the machine body part such that the plurality of sensors move together with the machine body part in the current direction of rotation during machine operation, and an evaluation and control unit configured to control the machine body part in response to sensor signals from the plurality of sensors, wherein the plurality of sensors comprise a first sensor configured to monitor a first defined spatial sector and to generate a first sensor signal when an object is detected in the first spatial sector, wherein the plurality of sensors comprise a second sensor configured to monitor a second defined spatial sector and to generate a second sensor signal when an object is detected in the second spatial sector, wherein the plurality of sensors comprise a third sensor configured to monitor a third defined spatial sector and to generate a third sensor signal when an object is detected in the third spatial sector, wherein the first spatial sector, the second spatial sector and the third spatial sector are different from each other, wherein the first and second spatial sectors are adjacent to one another during machine operation, wherein the second and third spatial sectors are adjacent to one another during machine operation, and wherein the first spatial sector, the second spatial sector and the third spatial sector are distributed around the axis of rotation during machine operation such that the first spatial sector, the second spatial sector and the third spatial sector follow one another in the current direction of rotation when the machine body part rotates about the axis of rotation.

The sensors of the new safety device are rigidly connected to the rotating machine body part and thus change their current “viewing direction” in response to the rotational movement of the machine body part. The spatial sectors rotate together with the machine body part around the axis of rotation and are therefore quasi-stationary in relation to the moving machine body part. However, the monitored spatial sectors move in relation to a fixed point in the vicinity of the ma-chine. This distinguishes the new safety device from concepts that use fixed sensors to monitor static spatial areas. The new safety device makes it possible to get along with a comparatively small number of sensors, which contributes to efficient and cost-effective implementation.

Furthermore, the monitored spatial sectors lie next to each other in the plane of rotation and therefore follow each other as the machine body part rotates. The plane of rotation is essentially perpendicular to the axis of rotation, in particular orthogonal to the axis of rotation. This means that the monitored spatial sectors sweep over the same spatial areas one after the other along the current direction of rotation. The new safety device thus differs conceptually from the safety device of the aforementioned EP 3 909 727 A1. The at least three spatial sectors following or leading one another make it possible to increase the productivity of the machine by triggering a creep speed at slow speed or a safety stop only when an object to be protected, such as in particular a person or a part of a person's body, is directly in the movement range of the moving machine body part. The movement path of the machine body part can be divided into very critical and less critical spatial areas in a very simple and cost-effective way due to the arrangement of the moving spatial sectors. The safety distances at which a safety function is triggered can be reduced compared to known safety devices. Unnecessary creeping movements at slow speeds can be reduced to a minimum. At the same time, however, the rotating spatial sectors mean that a safety stop or creep speed can be triggered at any time if a person is located directly in front of the machine body part in the current direction of rotation.

Preferably, the sensors mentioned above each are radar sensors, because radar radiation with electromagnetic waves from the microwave range is very robust against fog, dust, dirt, flying sparks or rain. In preferred exemplary embodiments, the radar sensors work with an operating frequency in the range from 10 GHz to 80 GHz, preferably with an operating frequency in the range between 20 GHz and 30 GHz or with an operating frequency in the range between 60 GHz and 70 GHz. These frequency ranges enable fast and positionally accurate detection of collision objects even when the above-mentioned environmental factors impair a “clear view”. This makes these sensors ideal for harsh industrial environments. Alternatively, the sensors mentioned above could in principle be lidar sensors that work with light from the optical and/or infrared wavelength range, cameras or ultrasonic sensors. A combination of different sensor principles is also conceivable for the plurality of sensors.

In a preferred refinement, the sensors each monitor a pie-shaped spatial sector that ex-tends from the respective sensor over an azimuthal opening angle that is greater than an opening angle in elevation. Preferably, the azimuthal opening angle is in the plane of rotation of the respective sensor. The opening angle in elevation is preferably defined parallel to the axis of rotation. In some advantageous exemplary embodiments, the azimuthal opening angle lies in a range between 20° and 120° and the opening angle in elevation lies in a range between 10° and 30°. The adjacent spatial sectors can overlap at their respective boundaries. Preferably, the angular range in which the adjacent spatial sectors overlap is small compared to the respective opening angle. In preferred exemplary embodiments, the azimuthal overlap angle of two adjacent spatial sectors is at most 20% of the respective azimuthal opening angle, preferably at most 10%. Accordingly, each of the three sensors mentioned above monitors more than half of the spatial sec-tor assigned to it exclusively. Preferably, each of the three sensors mentioned above exclusively monitors more than 75% of the spatial sector assigned to it.

This refinement makes an advantageous contribution to maximizing the productivity of the machine by reducing or even avoiding unnecessary false shutdowns and creep movements of the machine and only triggering a safety function in the form of a shutdown or creep movement by the new safety device in necessary cases.

In a further refinement, the evaluation and control unit is configured to limit a rotational speed of the machine body part about the rotational axis to a defined value greater than zero in a fail-safe manner in response to the first sensor signal, the second sensor signal and the third sensor signal.

In this refinement, the machine body part is moved at a reduced rotational speed com-pared to machine operation without any disturbance. The so-called creep speed of the machine body part, when an object is detected in the respective spatial sector leading in the direction of rotation, advantageously contributes to maintaining the productivity of the machine, albeit with a slower movement due to the risk of collision in the spatial sector leading in the direction of rotation.

In a further refinement, the machine body part has a contour leading in the current direction of rotation, wherein the first spatial sector is arranged in front of the leading contour in the current direction of rotation, wherein the second spatial sector is arranged in front of the first spatial sector in the current direction of rotation, wherein the third spatial sector is arranged in front of the second spatial sector in the current direction of rotation, and wherein the evaluation and control unit is configured to rotate the machine body part about the axis of rotation selectively at a first or at a second speed, wherein the first speed is higher than the second speed, and wherein the evaluation and control unit rotates the machine body part about the axis of rotation at the first speed if the first sensor signal indicates no object in the first spatial sector.

In this refinement, the new safety device allows the machine body part to move at a high speed compared to creep speed if the spatial sector immediately ahead in the current direction of rotation is free, or, respectively, the assigned sensor does not detect a potential collision object in the first spatial sector immediately ahead. In this refinement, allowing the movement of the machine body part at the high speed therefore decisively depends on the state in the first leading spatial sector or on the sensor signal of the first leading sensor, respectively. The refinement makes it possible for the machine body part to be rotated at a high speed, even if an object is detected in a further leading spatial sector or in a trailing spatial sector. The refinement enables particularly high productivity because the number and/or duration of less productive creeping movements is reduced.

In a further refinement, the evaluation and control unit limits a current rotational speed of the machine body part about the rotational axis to the second speed if the first sensor signal indicates an object in the first spatial sector.

In this refinement, the machine body part is limited to creep speed by the new safety de-vice if a potential collision object is detected in the leading first spatial sector. This refinement ensures a high level of operational safety and advantageously contributes to safe operation of the monitored machine while maintaining high productivity.

In a further refinement, the evaluation and control unit is configured to reverse the direction of rotation of the machine body part and to selectively rotate the machine body part at the first speed about the axis of rotation when the third sensor signal indicates no object in the third spatial sector.

In this refinement, the decisive role of the leading spatial sector changes from the first sensor to the third sensor when the direction of rotation of the machine body part is reversed. This refinement contributes in an advantageous manner to a dynamically adapted safeguarding of the machine.

In a further refinement, the evaluation and control unit has a fail-safe first evaluation and control unit and a non-fail-safe second control unit, wherein the second control unit controls the movement of the machine body part in response to an operating program and in response to a binary enable signal from the first evaluation and control unit, and wherein the first evaluation and control unit generates the binary enable signal in response to the first, second and third sensor signals.

As mentioned above, “fail-safe” in this case means that the first evaluation and control unit fulfills the requirements of category 3 or the requirements for the so-called performance level PL d according to the standard EN ISO 13849-1 and/or the safety requirement level SIL 3 ac-cording to the standard IEC 61508 or the machine-specific sector standard EN 62061. In contrast, the second control unit does not meet these requirements. It is therefore a so-called standard control unit, which essentially controls the desired operating sequence of the machine in accordance with an operating program. The refinement enables safe and productive operation of the machine in a cost-effective manner. In particular, this refinement allows a machine that was previously secured in a different way to be retrofitted with the new safety device and therefore achieve increased productivity without extensive changes to the desired operating sequence.

Preferably, the first evaluation and control unit generates two mutually redundant binary enable signals, each of which can have a high signal level (on state) or a low signal level (off state). The high signal level indicates that, in particular, the first spatial sector leading in the direction of rotation is free. The second control unit can then rotate the machine body part at a high rotational speed if this is intended in the desired operating sequence. The high signal level is therefore a fail-safe enable signal for the high rotational speed. The low signal level, on the other hand, indicates that the enable signal is no longer present, which means that the second control unit moves the machine body part at a limited, slow rotational speed at best. Preferably, the first evaluation and control unit generates the two redundant binary enable signals each with a test pulse, i.e. defined pulses from the high signal level to the low signal level. The test pulses make it possible to detect a stuck-at-high failure in the output circuit of the first evaluation and control unit. Preferably, the test pulses of the two mutually redundant binary enable signals are out of phase with each other, which enables advantageous cross-circuit detection. The refinement enables a simple, hard-wired handshake between the first evaluation and control unit and the non-fail-safe second control unit.

In a further refinement, the first sensor, the second sensor and the third sensor are connected in series to the evaluation and control unit.

In preferred exemplary embodiments, the series connection comprises a serial bus, such as a CAN bus in particular, via which the sensors communicate with the (first) evaluation and control unit. This refinement simplifies the installation of the sensors on the machine and contributes to a very cost-effective implementation.

In a further refinement, at least one sensor from the plurality of sensors has a first detection area and a separate second detection area within the associated spatial sector, wherein the first detection area is closer to said sensor than the second detection area, wherein said sensor generates separate sensor signals for each of the two detection areas, and wherein the evaluation and control unit is configured to control the rotation of the machine body part in response to the separate sensor signals.

In this refinement, the spatial sector of the at least one sensor is divided into two different distance ranges. Advantageously, all of said sensors from the plurality of sensors have such a first and separate second detection range within the respective monitored spatial sectors. The refinement makes it possible in a simple way for the evaluation and control unit to trigger different reactions depending on the distance of an object in the monitored spatial sectors. Advantageously, the evaluation and control unit can generate an optical and/or acoustic warning signal in the case of a greater distance in order to prevent a person from entering the working area of the machine any further. On the other hand, the evaluation and control unit can immediately reduce the speed of movement of the machine body part when an object is detected at a shorter distance and/or stop the movement of the machine body part. Alternatively, the evaluation and control unit can also reduce the rotational speed of the machine body part as soon as the warning signal is generated. The refinement helps to achieve high productivity together with safe operation of the machine.

In a further refinement, the plurality of sensors form a first sensor group and a second sensor group, wherein the sensors of the first sensor group define a first plane during machine operation, wherein the sensors of the second sensor group define a second plane during ma-chine operation, and wherein the first plane lies vertically below the second plane.

This refinement enables advantageous all-round protection of the moving machine body part with a small number of sensors. In preferred exemplary embodiments, the first level is close to the floor, i.e. the monitored spatial sectors of the sensors from the first sensor group extend down to the floor. They rest on the floor, so to speak. The sensors of the first sensor group advantageously have a main viewing direction that is essentially perpendicular to the axis of rotation. In preferred exemplary embodiments, in contrast, the main direction of view of the sensors of the second sensor group runs at an angle to the main direction of view of the sensors of the first sensor group, in particular at an angle to the floor. The sensors of the first sensor group can be used to efficiently monitor the spatial area around the moving machine body part, but without the moving machine body part itself. The sensors of the second sensor group, on the other hand, can be used to monitor a spatial area radially in front of the moving machine body part, as it were from diagonally above, without the machine body part obscuring the line of sight of the sensors of the second sensor group.

In a further refinement, accordingly, the sensors of the first sensor group jointly monitor an azimuthal spatial area that omits the machine body part. In a further refinement, the sensors of the second sensor group jointly monitor an azimuthal spatial area that extends behind the ma-chine body part as seen by the sensors of the second sensor group.

With these refinements, an advantageous all-round protection of the moving machine body part can be achieved efficiently. If all-round protection is not required, for example because access to the moving machine part from some radial directions is prevented by fences or other separating protective devices, the sensor group that is not required can be omitted in a cost-effective manner.

In a further refinement, the machine body part executes a rotary movement over a de-fined rotary angle range during machine operation, with the first spatial sector, the second spatial sector and the third spatial sector each covering a sub-range of the defined rotary angle range.

In some preferred exemplary embodiments, the sub-ranges covered by the first spatial sector, the second spatial sector and the third spatial sector are approximately equal in size. For example, the first spatial sector, the second spatial sector and the third spatial sector each cover one third of the defined rotation angle range. In other exemplary embodiments, the first spatial sector and the third spatial sector each cover a larger rotation angle sub-range than the second spatial sector. In some exemplary embodiments, the first spatial sector, the second spatial sector and the third spatial sector each cover an angle of rotation range of between 45° and 90°.

The refinement enables very efficient protection of a robot work cell with a small number of sensors.

It is understood that the features mentioned above and those yet to be explained below can be used not only in the combination indicated in each case, but also in other combinations or in a stand-alone position, without going beyond the scope of the present invention.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 an exemplary embodiment of the new safety device on an articulated robot.

FIG. 2 the safety device of FIG. 1, whereby three monitored spatial sectors are schematically shown.

FIG. 3 the safety device of FIG. 1, whereby three further monitored spatial sectors are schematically shown.

In the drawings, reference numbers may be reused to identify similar and/or identical elements.

### DETAILED DESCRIPTION

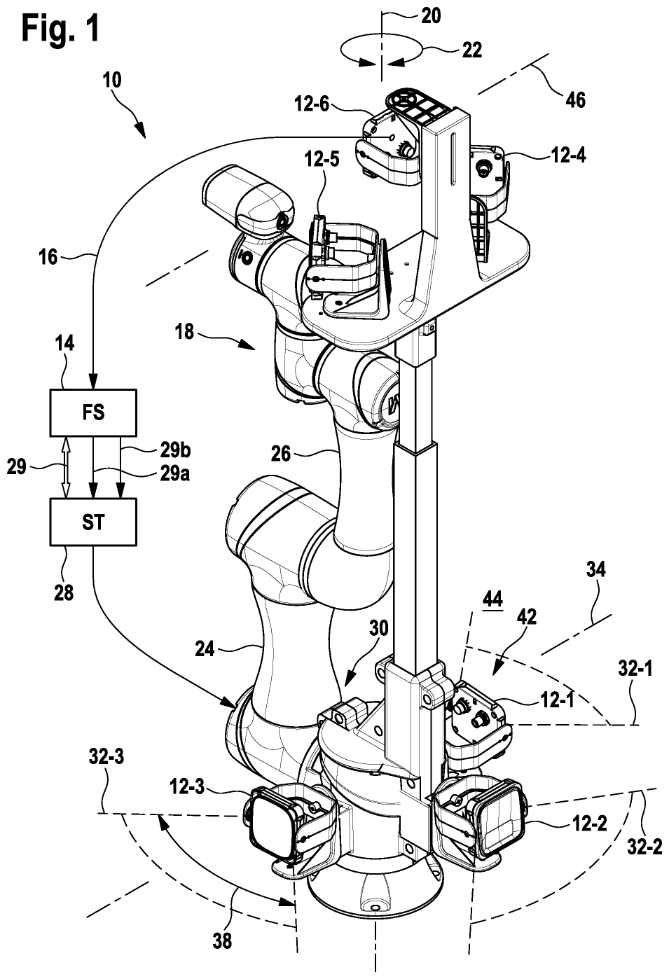

In FIG. 1, an exemplary embodiment of the new safety device is designated by the reference number 10 in its entirety. In this exemplary embodiment, the safety device 10 comprises 6 radar sensors 12-1, 12-2, 12-3, 12-4, 12-5 and 12-6, which are hereinafter collectively referred to by reference numeral 12, and a fail-safe evaluation and control unit 14, which in this case is connected to the radar sensors 12 via a serial bus connection 16 (only schematically indicated here). In preferred exemplary embodiments, the serial bus connection 16 is based on a CAN bus protocol, which enables very efficient data transmission between the sensors connected in series and the evaluation and control unit 14. In some exemplary embodiments, the evaluation and control unit 14 comprises a fail-safe controller called PNOZmulti 2, which is commercially avail-able from the applicant Pilz GmbH & Co KG, based in 73760 Ostfildern, Germany.

The sensors 12 are arranged in this case on an articulated arm robot 18 and, accordingly, can rotate together with the robot 18 about an axis of rotation 20 of the robot 18. In this case, the axis of rotation 20 is the first of several axes of rotation of the robot 18 and it runs here perpendicular to the floor on which the robot 18 is placed with its base. In some exemplary embodiments, the robot 18 can perform pick-and-place tasks, whereby it rotates in alternating directions around the axis of rotation 20. A respective current direction of rotation is indicated at reference numeral 22. As is known to those skilled in the art, the robot 18 here has several arm parts which are rotatably connected to one another via further rotary joints. Some of these arm parts are designated here by reference numerals 24, 26. The rotations of the arm parts 24, 26 relative to one another and the rotation of the robot 18 about the axis of rotation 20 are controlled here by a non-fail-safe control unit 28. The control unit 28 can be a conventional robot controller, as typically offered by the manufacturer of the robot 18 and supplied together with the robot. The control unit 28 controls the desired operational sequence of the robot 18 in a manner known per se in accordance with an operational program, which is typically loaded into the control unit 28. In some preferred exemplary embodiments, the evaluation and control unit 14 and the operational control unit 28 of the robot may communicate with each other via a bidirectional connection 29. In some exemplary embodiments, the connection 29 may comprise a fail-safe bus connection, for example based on a fail-safe Ethernet protocol. In preferred exemplary embodiments, the connection 29 comprises two or more redundant, binary enable signals 29a, 29b, so-called OSSD signals, such as those provided by the applicant's fail-safe controller PNOZmulti 2.

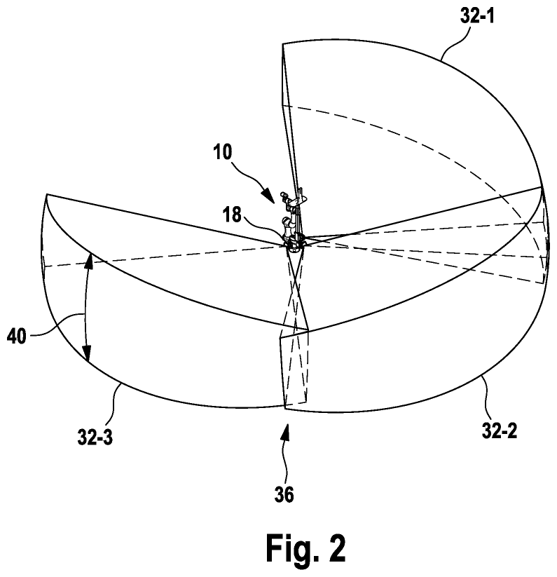

Depending on the operating situation, the movable arm parts 24, 26 form a contour 30 that leads in the current direction of rotation 22, which contour can exert a high contact force on a person or another object (not shown here) in the event of a collision with the person or the object in the rotation range of the robot 18. To prevent this, the sensors 12 each monitor a defined, assigned spatial sector 32. In FIG. 1, a first spatial sector 32-1, a second spatial sector 32-2 and a third spatial sector 32-3 are each indicated by dashed lines. By way of example, the first sensor 12-1 monitors the first spatial sector 32-1, the second sensor 12-2 monitors the second spatial sector 32-2 and the third sensor 12-3 monitors the third spatial sector 32-3 in this case. The three spatial sectors 32-1, 32-2 and 32-3 are adjacent to one other and the sensors 12-1, 12-2 and 12-3 define a plane 34, which in this case is close to the ground and largely parallel to the ground. FIG. 2 shows the three spatial sectors 32-1, 32-2 and 32-3 in a perspective view.

As can be seen from FIG. 2, the monitored spatial sectors 32-1, 32-2 and 32-3 overlap from a certain distance in the adjoining areas, so that the three sensors 12-1, 12-2 and 12-3 here together cover a contiguous rotation angle range 36, which surrounds the robot 18 here on three sides. In the illustrated exemplary embodiment, the spatial sectors 32-1, 32-2 and 32-3 together cover a rotation angle range 36 which is approximately 270°. In this case, each of the three sensors 12-1, 12-2 and 12-3 monitors a spatial sector 32-1, 32-2 and 32-3 assigned to it, which respective sector covers approximately one third of the rotation angle range 36. The jointly monitored rotation angle range 36 extends in the azimuthal direction and does not comprise the robot 18 with the machine body parts 24, 26. Accordingly, the machine body parts 24, 26, more generally the robot 18, do not generate any radar reflections that could be detected by the sensors 12-1, 12-2 and 12-3 in this exemplary embodiment.

The division of the azimuthal spatial sector 36 into three largely equally sized monitored spatial sectors 32-1, 32-2, 32-3 has proven to be very advantageous in some exemplary embodiments in order to monitor the rotation angle range of the robot 18 with a small number of sensors in such a manner that the robot 18 can be operated with a high level of productivity. Advantageously, the fail-safe evaluation and control unit 14 generates the above-mentioned enable signals if the spatial sector immediately ahead in the current direction of rotation is “free”, i.e. the assigned sensor does not detect any potential collision object in the spatial sector it is monitoring. Thus, for example, if the robot 18 is to rotate clockwise in a defined operating situation, the evaluation and control unit 14 generates the above-mentioned enable signal if the spatial sector 32-1 is free, i.e. if the first sensor 12-1 does not detect a collision object in the spatial sector 32-1. Conversely, the evaluation and control unit 14 generates the above-mentioned enable signal if the robot 18 is to rotate counterclockwise in another operating situation and the spatial sector 32-3 is free, i.e. if the third sensor 12-3 does not detect a collision object in the spatial sector 32-3. Irrespective of this exemplary embodiment, in further exemplary embodiments in which the ma-chine body part 24, 26 passes through a rotation angle range of less than or equal to 300° during intended operation, it is advantageous if the safety device 10 monitors the said rotation angle range with three, four or at most five spatial sectors which together cover the entire rotation angle range.

As can also be seen in FIG. 2, the monitored spatial sectors 32-1, 32-2, 32-3 each have a shape that resembles a piece of a pie or cake in this case, i.e. corresponds to a sector of a circle in a plan view, but is limited in elevation. In other words, the azimuthal opening angle 38, which is indicated in FIG. 1 for the spatial sector 32-3 at reference numeral 38, is greater than the opening angle 40 in elevation.

In preferred exemplary embodiments, some or even all of the sensors from the plurality of sensors 12-1 to 12-6 have a first detection area 42 and a separate second detection area 44 within the respective monitored spatial sector (indicated in FIG. 1 using the example of the first sensor 12-1). The first detection area 42 is located closer to the respective sensor than the second detection area 44. The respective sensor generates separate sensor signals for each of the two detection areas 42, 44, and the evaluation and control unit 14, 28 is configured to control the rotation of the machine body part 24, 26 in response to the separate sensor signals. The separate detection areas 42, 44 make it possible to take into account a current distance of the potential collision object to the robot 18 when controlling the rotational movement. For example, if an object is detected in the second, more distant detection area 44, only a visual and/or acoustic warning signal can be triggered by the evaluation and control unit 14, 28 and only an object detection in the first detection area 42 triggers a reduction in the current rotational speed or even an emergency stop. In further exemplary embodiments, the evaluation and control unit 14, 28 can be configured to limit the current rotational speed of the machine body part in the event of an object detection in the more distant detection area 44 or to reduce it to creep speed, while an object detection in the closer detection area 42 always triggers an emergency stop. In principle, the monitored spatial sectors can also have more than two separate detection areas staggered in distance, whereby the evaluation and control unit 14, 28 is configured to control the rotary movement of the machine body part in response to the azimuthal position of the object (detected by means of the respective spatial sector or sensor signal) and by means of the respective distance (detected by means of the respective detection area).

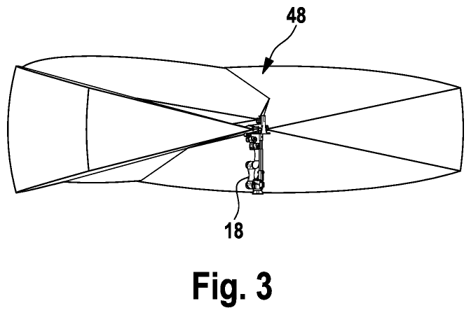

In the exemplary embodiment shown in FIG. 1, the safety device 10 has two sensor groups with a total of 6 sensors. The sensors 12-1, 12-2 and 12-3 form a first sensor group and define a level 34 close to the ground. The sensors 12-4, 12-5 and 12-6 are arranged on a plat-form above the sensors 12-1, 12-2 and 12-3 and form a second sensor group. The sensors 12-4, 12-5 and 12-6 of the second sensor group here define a plane 46 which lies vertically above the plane 34. As can be seen from FIGS. 1 and 3, the sensors 12-4, 12-5, 12-6 of the second sensor group together monitor a further azimuthal spatial region 48 which, as seen by the sensors 12-4, 12-5, 12-6 of the second sensor group, extends behind the robot 18 or its machine body parts 24, 26. The viewing direction of the sensors 12-4, 12-5, 12-6 of the second sensor group is here directed obliquely downwards from a position slightly above the robot 18. The spatial sec-tors monitored by the sensors 12-4, 12-5, 12-6 therefore cover in particular the gap left by the azimuthal spatial area 36 as shown in FIG. 2.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A safety device for safeguarding a danger zone of an articulated robot having a body part which, during operation, executes a rotary movement about an axis of rotation during robot operation and thereby defines a current direction of rotation, the safety device comprising:
a plurality of sensors configured to be mechanically coupled to the body part such that the plurality of sensors move together with the body part in the current direction of rotation during robot operation; and
an evaluation and control unit configured to control the rotary movement of the body part in response to sensor signals from the plurality of sensors,
wherein the plurality of sensors include a first sensor configured to monitor a first defined spatial sector and to generate a first sensor signal in response to an object being detected in the first spatial sector,
wherein the plurality of sensors include a second sensor configured to monitor a second defined spatial sector and to generate a second sensor signal in response to an object being detected in the second spatial sector,
wherein the plurality of sensors include a third sensor configured to monitor a third defined spatial sector and to generate a third sensor signal in response to an object being detected in the third spatial sector,
wherein the first spatial sector, the second spatial sector, and the third spatial sector are different from each other,
wherein the first and second spatial sectors are adjacent to one another during robot operation,
wherein the second and third spatial sectors are adjacent to one another during robot operation, and
wherein the first spatial sector, the second spatial sector, and the third spatial sector are distributed around the axis of rotation during robot operation such that the first spatial sector, the second spatial sector and the third spatial sector follow one another in the current direction of rotation in response to the body part rotating about the axis of rotation.

2. The safety device of claim 1 wherein the first, second, and third spatial sectors each define a pie-shaped configuration.

3. The safety device of claim 1 wherein:
the first, second, and third spatial sectors each extend over an azimuthal opening angle and an elevational opening angle, and
the azimuthal opening angle is greater than the elevational opening angle.

4. The safety device of claim 1 wherein:
the body part has a leading contour in the current direction of rotation,
the first spatial sector is arranged in front of the leading contour in the current direction of rotation,
the second spatial sector is arranged in front of the first spatial sector in the current direction of rotation,
the third spatial sector is arranged in front of the second spatial sector in the current direction of rotation,
the evaluation and control unit is configured to selectively rotate the body part at a first rotational speed or at a second rotational speed about the axis of rotation,
the rotational first speed is higher than the second rotational speed, and
the evaluation and control unit rotates the body part at the first rotational speed about the axis of rotation in response to the first sensor signal indicating no object in the first spatial sector.

5. The safety device of claim 4 wherein the evaluation and control unit is further configured to limit a current rotational speed of the body part about the rotational axis to the second rotational speed in response to the first sensor signal indicating an object in the first spatial sector.

6. The safety device of claim 4 wherein the evaluation and control unit is further configured to reverse the current direction of rotation of the body part and to selectively rotate the body part at the first rotational speed about the axis of rotation in response to the third sensor signal indicating no object in the third spatial sector.

7. The safety device of claim 1 wherein:
the evaluation and control unit includes a fail-safe first evaluation and control unit and a non-fail-safe second control unit,
the second control unit is configured to control the movement of the body part in response to an operating program and in response to a binary enable signal from the first evaluation and control unit, and
the first evaluation and control unit is configured to generate the binary enable signal in response to the first, second, and third sensor signals.

8. The safety device of claim 1 wherein the first sensor, the second sensor, and the third sensor each are connected in a series connection to the evaluation and control unit.

9. The safety device of claim 1 wherein:
the first spatial sector includes a first detection area and a separate second detection area,
the first detection area is closer to the first sensor than the second detection area,
the first sensor is configured to generate separate first sensor signals for each of the first and second detection areas, and
the evaluation and control unit is configured to control the rotation of the body part in response to the separate first sensor signals.

10. The safety device of claim 1 wherein:
the plurality of sensors form a first sensor group and a second sensor group,
the sensors of the first sensor group define a first plane during robot operation,
the sensors of the second sensor group define a second plane during robot operation, and
the first plane is vertically below the second plane.

11. The safety device of claim 10 wherein the sensors of the first sensor group jointly monitor an azimuthal spatial region which omits the body part.

12. The safety device of claim 11 wherein the sensors of the second sensor group jointly monitor a further azimuthal spatial region which, as seen by the sensors of the second sensor group, extends behind the body part.

13. The safety device of claim 1 wherein:
the body part is configured to execute a rotary movement over a defined rotary angle range during robot operation, and
the first spatial sector, the second spatial sector, and the third spatial sector each cover a partial range of the defined rotary angle range.

14. An automatically operating machine having a machine body part which, during machine operation, is configured to rotate about an axis of rotation, thereby defining a current direction of rotation, the machine comprising a safety device including:
a plurality of sensors configured to be mechanically coupled to the machine body part such that the plurality of sensors move together with the machine body part in the current direction of rotation during machine operation; and
an evaluation and control unit configured to control the machine body part in response to sensor signals from the plurality of sensors,
wherein the plurality of sensors include a first sensor configured to monitor a first defined spatial sector and to generate a first sensor signal in response to an object being detected in the first spatial sector,
wherein the plurality of sensors include a second sensor configured to monitor a second defined spatial sector and to generate a second sensor signal in response to an object being detected in the second spatial sector,
wherein the plurality of sensors include a third sensor configured to monitor a third defined spatial sector and to generate a third sensor signal in response to an object being detected in the third spatial sector,
wherein the first spatial sector, the second spatial sector, and the third spatial sector are different from each other,
wherein the first and second spatial sectors are adjacent to one another during machine operation,
wherein the second and third spatial sectors are adjacent to one another during machine operation, and
wherein the first spatial sector, the second spatial sector, and the third spatial sector are distributed around the axis of rotation during machine operation such that the first spatial sector, the second spatial sector, and the third spatial sector follow one another in the current direction of rotation in response to the machine body part rotating about the axis of rotation.

15. The automatically operating machine of claim 14 wherein the plurality of sensors each monitor a pie-shaped spatial sector which, starting from the respective sensor, extends over an azimuthal opening angle which is greater than a respective opening angle in elevation.

16. The automatically operating machine of claim 14 wherein:
the machine body part has a leading contour in the current direction of rotation,
the first spatial sector is arranged in front of the leading contour in the current direction of rotation,
the second spatial sector is arranged in front of the first spatial sector in the current direction of rotation,
the third spatial sector is arranged in front of the second spatial sector in the current direction of rotation,
the evaluation and control unit is configured to selectively rotate the machine body part at a first speed or at a second speed about the axis of rotation, the first speed is higher than the second speed, and
the evaluation and control unit rotates the machine body part at the first speed about the axis of rotation in response to the first sensor signal indicating no object in the first spatial sector.

17. The automatically operating machine of claim 16 wherein the evaluation and control unit is configured to limit a current rotational speed of the machine body part about the rotational axis to the second speed in response to the first sensor signal indicating an object in the first spatial sector.

18. The automatically operating machine of claim 16 wherein the evaluation and control unit is configured to reverse the current direction of rotation of the machine body part and to selectively rotate the machine body part at the first speed about the axis of rotation in response to the third sensor signal indicating no object in the third spatial sector.

19. The automatically operating machine of claim 14 wherein:
at least one sensor of the plurality of sensors has a first detection area and a separate second detection area within an associated spatial sector,
the first detection area is closer to the at least one sensor than the second detection area,
the at least one sensor generates separate sensor signals for each of the two detection areas, and
the evaluation and control unit is configured to control the rotation of the machine body part in response to the separate sensor signals.

20. The automatically operating machine of claim 14 wherein:
the plurality of sensors form a first sensor group and a second sensor group,
the sensors of the first sensor group define a first monitoring plane during machine operation,
the sensors of the second sensor group define a second monitoring plane during machine operation, and
the first monitoring plane is vertically below the second monitoring plane.

21. The automatically operating machine of claim 14 wherein:
the machine body part executes a rotary movement over a defined rotary angle range during machine operation, and
the first spatial sector, the second spatial sector, and the third spatial sector each cover a partial range of the defined rotary angle range.
